(19) United States
(12) Patent Application Publication
(10) Pub. No.: US 2004/0120539 A1
(43) Pub. Date: Jun. 24, 2004

(54) Hearing aid fitted with a rechargeable battery and a method of forming such a hearing aid

(75) Inventor: Frank Panitzsch, Grossmonra OT Burgwenden (DE)

Correspondence Address: RANKIN, HILL, PORTER & CLARK, LLP, 925 EUCLID AVENUE, SUITE 700, CLEVELAND, OH, 44115-1405, US

(73) Assignee: HANSATON AKUSTIK GMBH, Hamburg (DE)

(21) Appl. No.: 10/716,010

(22) Filed: Nov. 18, 2003

Related U.S. Application Data
(63) Continuation-in-part of application No. 09/860,159, filed on May 17, 2001, now abandoned.

(30) Foreign Application Priority Data
May 17, 2000 (DE) 100 23 907.2

(51) Int. Cl. H04R 25/00

(52) U.S. Cl. 381/312; 381/323; 381/330

(57) ABSTRACT

A hearing aid (1) having a case (3) enclosing its electrical components, which includes at least one rechargeable battery (10). The rechargeable battery is a solid-state rechargeable battery or a foil rechargeable battery.

### CROSS REFERENCE TO RELATED APPLICATION

This application is a continuation-in-part of U.S. patent application Ser. No. 09/860,159 filed May 17, 2001, which is herein incorporated by reference.

### BACKGROUND OF THE INVENTION

1. Field of the Invention

The invention relates to a hearing aid fitted with a rechargeable battery and further to the use of a planar solid-state rechargeable battery or a foil rechargeable battery to power a hearing aid.

2. Description of Related Art

In general a hearing aid includes a microphone, an amplifier, a loudspeaker or ear phone, operating elements such as ON/OFF switches and a volume control, an ear hook and ear adapter, and a power source.

Conventional power sources used for such hearing aids are, for instance, button cells with a service life of several days or small rechargeable batteries with service lives of about twelve hours, these small rechargeable batteries also being in the form of a button cell.

Hearing aids demand maximum compactness and minimum weight in order to be comfortable, unobtrusive, and easy to wear. This is especially the case for the so-called behind-the-ear hearing aids and the hearing glasses, furthermore to the still smaller in-ear hearing aids, which are accommodated directly in the auditory canal.

However, the rechargeable batteries used so far suffer from inadequate energy density and, moreover, are available only in particular sizes and shapes. These batteries are, as a rule, cylindrical button cells, which interferes with the compactness and ease of wearing of these hearing aids.

### SUMMARY OF THE INVENTION

Accordingly, it is an objective of the present invention to create a rechargeable battery substantially eliminating the above-cited drawbacks of the rechargeable batteries of the state of the art.

The terminology “foil rechargeable battery” herein shall denote a lithium polymer rechargeable battery such as described in the periodical MARKT & TECHNIK, Nr. 34, 1999, p 38, wherein an electrolytic gel is used. These batteries may, for instance, be fitted with a flexible external case. A rechargeable battery of this kind is known, for instance, as Panasonic SSP35623.6, which, however, is used in mobile telephones and also is optimized for that market. Rechargeable batteries based on lithium polymer technology are characterized by high energy densities of 250 watt-h per liter or 120 watt-h per kg and 500 charge/discharge cycles.

Comparable properties are also offered by the solid-state rechargeable battery developed in collaboration between the FRAUNHOFER INSTITUT FÜR SILIZIUMTECHNOLOGIE and the technical faculty of Kiel University and described for instance in the SCOPE periodical of November 1999 on pp 84, wherein a solid-state electrolyte replaces the heretofore mostly corrosive electrolytic liquid. Moreover, the solid-state electrolytes can be processed in a pressurized manner into foils and be made to assume any desired shape.

Both types of rechargeable batteries offer not only high energy densities and satisfactory recharging, but also allow wide variations in their geometries. This feature is made possible in that the electrolytes exhibit large chemical inertness and, as a result, the rigid, leak-proof and costly metal cases of conventional rechargeable batteries may be eliminated in favor of flexible external cases. However, to-date the rechargeable batteries have assumed a square shape.

It is the insight of the invention that the button cells heretofore used in hearing aids may be advantageously replaced by the above-mentioned solid-state or foil rechargeable batteries. A feature of these solid-state or foil rechargeable batteries to be exploited is that they can be made in arbitrary geometries and, so-to-speak, in customized form. Together with the improved energy density of the solid-state or foil rechargeable batteries compared to that of the button cells, such a design better utilizes the scant space within a hearing-aid case. The space that was used for the button cells is now superfluous and thus may be used in other ways, for instance to house electronic components, or the hearing aid may be made more compact.

In principle the rechargeable battery of the invention may be configured in an arbitrary external geometry and disposed at an arbitrary place within the housing. However, in an advantageous design the rechargeable battery shall match at least a portion of the hearing aid's housing inner surface. Easy shaping of the rechargeable batteries makes it possible to mount them on the inside wall of a portion of the housing. Although this feature entails abandoning the known cylindrical or parallelepipedic shapes of conventional rechargeable batteries, it does not create difficulties in the manufacture of foil or solid-state rechargeable batteries.

In principle, the rechargeable battery may be mounted anywhere inside the case. Illustratively, the solid-state or foil rechargeable battery may be in the shape of a button cell receptacle. However, only the improved energy density would then be exploitable, not the freedom to assume various shapes. Accordingly, this solution is not viewed as being optimal. If the hearing aid case consists, for instance, of a peripheral frame, a base plate, and a top plate, then the rechargeable battery according to the present invention may be advantageously mounted on the inside of the base plate or on the inside of the top plate or on both. In this manner optimal use is made of the space between the hearing aid's printed circuit board and the plate(s). The hearing aid may not need to be modified since this space is already present. The peripheral frame, per se, in general does not offer enough space to mount the rechargeable battery thereto.

In further accordance with the present invention, the rechargeable battery could be glued to the inside of a zone or portion of the case. Even though the battery is rechargeable, it may be necessary to exchange it and, advantageously, the rechargeable battery is designed to be exchangeable and is mounted accordingly.

In an especially advantageous manner, the rechargeable battery is mounted on the inside of a detachable plate. This feature facilitates accessing the rechargeable battery and allows the technician to easily and quickly access, remove, and replace the rechargeable battery. Moreover, the rechargeable battery may be exchanged together with the plate to the inside of which it is affixed. This is quickly carried out manually by the acoustic technician. However, even if the rechargeable battery were mounted on the inside surface of a permanent base plate, it still can be exchanged, though more laboriously, because first the electronic components configured in the hearing aid's peripheral frame must be removed in order to access the rechargeable battery.

The rechargeable battery must be electrically connected to the hearing aid's electric components. Therefore, the battery is fitted with appropriate terminals which, for instance when the lid is closed, will make contact with contact surfaces on the hearing aid's printed circuit board and thus implement electrical connection.

### BRIEF DESCRIPTION OF THE DRAWINGS

Further features and particulars of the invention are indicated in the attached drawings where:

FIG. 1 shows in an illustrative and diagrammatic manner an exploded perspective view of a behind-the-ear hearing aid according to a first embodiment of the present invention; and

FIG. 2 shows in an illustrative and diagrammatic manner an exploded perspective view of a second behind-the-ear hearing aid according to a second embodiment of the present invention.

### DETAILED DESCRIPTION OF THE PREFERRED EMBODIMENTS

As used herein, a “laminar battery” or a “battery that is laminar” or similar phraseology shall mean a thin battery having a substantially uniform thickness that is significantly less than the width and length of the battery. Such a laminar battery may be planar, curved, bent or otherwise configured.

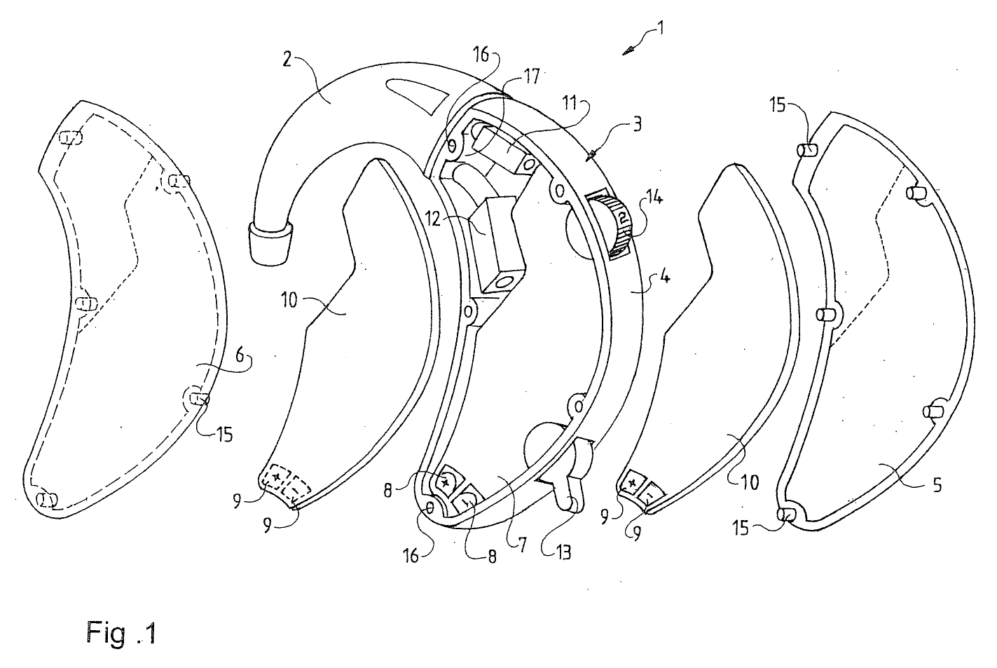

Referring now to FIG. 1, a behind-the-ear hearing aid 1 is shown, which comprises an ear hook 2 which adjoins an ear matching element (not shown). This ear matching element is a plastic cast of the outer auditory canal and implements acoustic transmission to the ear drum while suppressing feedback.

The ear hook 2 adjoins a case 3 of the hearing aid 1. The electronic components of the hearing aid 1 are mounted in this case 3. The case 3 is curved such that, when in use, the hearing aid is appropriately positioned behind the wearer's ear and makes contact over the largest possible surface.

In the shown embodiment, the case 3 consists of a peripheral frame 4, a detachable base plate 5, and a detachable cover plate 6. A printed circuit board 7 is mounted inside the frame 4 and seats the electronic circuits and components. The printed circuit board 7 is fitted at its lower end with two contacts 8 for making electrical contact with the negative or positive terminal 9 of a rechargeable battery 10. As shown in FIG. 1, the printed circuit board 7 has an overall shape that conforms to the overall shape of the battery 10. The lower sides facing the printed circuit board 7 may be spring-loaded in order to assure proper electrical contact between the positive and negative terminals 9 of the rechargeable battery 10 and the contacts 8 when the case 3 is closed.

In the embodiment shown, the top plate 5 and the base plate 6 each receive and hold a rechargeable battery 10 of the invention. Accordingly the printed circuit board 7 has contacts 8 on its top and bottom sides.

Moreover, a microphone 11, an ear piece or speaker 12 and operating elements passing through the frame 4 are mounted within the frame 4. The hearing aid 1 can be activated/deactivated by the ON/OFF switch 13 and the volume can be adjusted by means of the volume control 14 illustratively in the form of a potentiometer.

Power to the hearing aid is provided by the rechargeable batteries 10 which, in the shown embodiment, are mounted one on the inside of the base plate 5 and one on the inside of the top plate 6. At the side facing the printed circuit board 7, each rechargeable battery 10 has positive and negative terminals 9 that are aligned with corresponding contacts 8 fitted onto the printed circuit board 7. The batteries 10 are solid-state rechargeable batteries or foil rechargeable batteries. The batteries 10 substantially correspond to the topography of the inside surfaces of the associated two case parts (plates 5 and 6). More specifically, and as shown in FIG. 1, the batteries 10 are configured to have shapes that conform to major portions of the interior surfaces of the base and top plates 5, 6, respectively. In this regard, it should be appreciated that the shapes of the batteries 10 are determined by the configuration of the interior of the case 3, namely the interior surfaces of the base and top plates 5, 6. In other words, the configuration of the interior of the case 3 dictates the shape of the batteries 10. This feature of the present invention is in direct contrast to conventional hearing aids, wherein the shape of the battery dictates the configuration of the interior of the case. In conventional hearing aids, the interior of the case must be especially designed to accommodate a standard, mass-produced button cell battery.

With specific reference now to the shape of the case 3 shown in FIG. 1, the case 3 is designed to have a substantially kidney-shaped configuration, with a smooth, substantially uninterrupted exterior surface. In this manner, the case 3 combines with the ear hook 2 to provide the hearing aid 1 with a smooth, substantially continuous, curved tear drop shape that permits the hearing aid 1 to be hooked around a top portion of a user's ear, such that the hearing aid 1 is supported on the user's ear. When the hearing aid 1 is so disposed, the case 3 snugly curves around an upper rearward portion of the user's ear and is predominantly disposed behind the user's ear. The case 3 is relatively flat so that the case 3 does not obtrusively project outward beyond the user's ear. The low profile of the case 3 in combination with the smooth uninterrupted exterior surface provides the case 3 and the hearing aid 1 with an aesthetically appealing appearance.

The construction of the batteries 10 permits the case 3 to be designed to have the ergonomic and aesthetically pleasing configuration described above, without regard to any specific dimensional requirements of the batteries 10. More specifically, based on the desired overall appearance and functionality of the hearing aid 1, the case 3 is designed to have the base and top plates 5, 6 and to provide them with substantially kidney-shape configurations with smooth, uninterrupted exterior surfaces. Except for a raised peripheral ridge, each of the base plate 5 and the top plate 6 have a uniform thickness. As a result, the base plate 5 and the top plate 6 have interior surfaces (inward of the peripheral ridges) that conform to the exterior surfaces of the base and top plate 5, 6, respectively, i.e., the interior surfaces are smooth and substantially uninterrupted, as is shown in FIG. 1. The batteries 10 are designed to conform to all of the interior surfaces of the base and top plates 5, 6, respectively, except for the portions of the base and top plates 5,6 that overly the microphone 11 and the speaker 12, since it is desired to keep the spaces between the microphone 11 and the base and top plates 5, 6 open in order to avoid blocking sound transmission to the microphone 11. Based upon the foregoing design considerations, the batteries 10 are laminar and mostly kidney-shaped in configuration. More specifically, each battery 10 has a first or upper end and a second or lower end, with a first or outer side edge and a second or inner side edge extending therebetween. The outer side edge is disposed away from the user's ear, while the inner side edge is disposed toward the user's ear. The outer side edge is arcuate and extends convexly between the upper and lower ends. The inner side edge is irregular, having a lower arcuate and concave portion and an upper stepped portion.

The batteries 10 are mounted by glue or otherwise to the base and top plates 5,6 such that the batteries 10 are disposed very close to or adjoining a majority of the interior surfaces of the base and top plates 5, 6, respectively. In this manner, the batteries 10 form a type of layer that extends over all of the interior surfaces of the base and top plates 5, 6, respectively, except for the portions of the base and top plates 5,6 that overly the microphone 11 and the speaker 12. As can be appreciated, such construction and placement of the batteries 10 saves a considerable amount of space and permits the case 3 to have the ergonomic and aesthetic construction that it does.

With the batteries 10 constructed and positioned as described above, the batteries 10 cover the top and bottom sides of the printed circuit board 7, respectively, when the base and top plates 5, 6 are attached to the frame 4. In addition, when the base and top plates 5, 6 are attached to the frame 4, the batteries 10 cover all of the top and bottom sides of the opening in the frame 4, except the portions of the opening within which the microphone 11 and the speaker 12 are disposed.

Both the base plate 5 and the top plate 6 can be detached in a snap-out manner from the frame 4. For that purpose each is fitted with peripheral snap-in pins 15 on the side facing the frame 4. The frame 4, in turn, is fitted with seats 16 in the form of through bores in reinforced frame zones 17. The seats 16 match the array and size of the snap-in pins and cooperate with the pins to secure the plates 5, 6 to the frame 4.

The above described solid-state or foil rechargeable batteries may be charged and discharged several hundred times. Recharging the batteries 10, for instance, may be carried out such that the batteries discharged through use are removed from the hearing aid by taking off its top or base plate and then are placed into a charger, for instance being configured on the inside surface of the plates, and the hearing aid being re-assembled following recharging. Such a procedure, however, is cumbersome.

Recharging may be carried out more simply using contacts that are situated at the outside surface of the base or top plate and that are electrically connected to the rechargeable batteries or a charging circuit, whereby the hearing aid can be placed as a whole into a corresponding charger. In this configuration the disassembly and reassembly of the hearing aid is be avoided.

Alternatively, furthermore, recharging may be carried out inductively. The space freed by the elimination of the button cell might be used to house an appropriate charging circuit with a receiver coil.

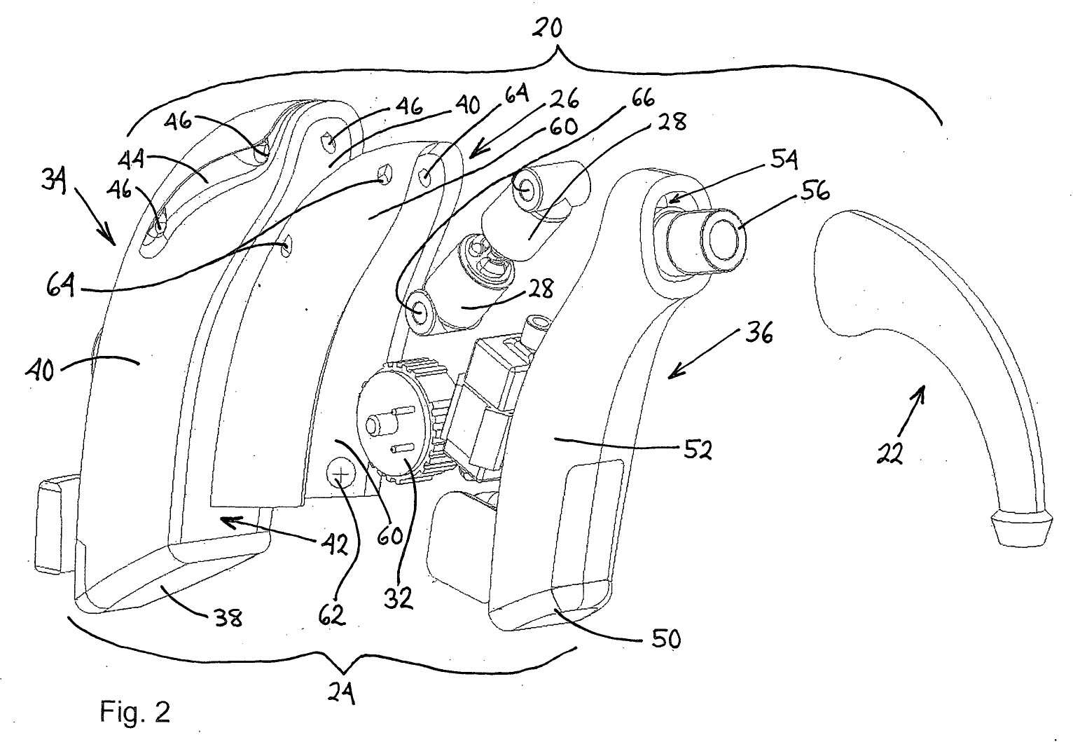

Referring now to FIG. 2, there is shown a hearing aid 20 constructed in accordance with a second embodiment of the present invention. The hearing aid 20 includes an ear hook 22, a case 24, a battery 26 and electronics, including a pair of microphones 28 and a volume control 32.

The case 24 has a curved shape and includes first and second sections or shells 34, 36 that are adapted to be releasably secured to each other. The first shell 34 includes a base wall 38 joined to bottom edges of a pair of spaced-apart side walls 40. The base wall 38 and the side walls 40 have interior surfaces that cooperate to define an interior space or cavity 42. Front edges of the side walls 40 and a front edge of the base wall 38 cooperate to provide the first shell 34 with a peripheral front edge that defines an opening for providing access to the cavity 42. Upper and rear portions of the side walls 40 curve inwardly and are joined together to form a rear bend that arcuately extends upwardly and forwardly from the base wall 38 to the front edges of the side walls 40. In this manner, the rear bend is arcuate in the lateral and longitudinal directions. A pair of grooves 44 are formed in exterior top portions of the side walls 40, respectively. In each side wall 40, a pair of sound transmission holes 46 are disposed in the groove 44 and extend through the side wall 40.

The second shell 36 includes a base wall 50 joined to bottom edges of a pair of spaced-apart side walls 52. The base wall 50 and the side walls 52 have interior surfaces that cooperate to define an interior space or cavity (not shown), which is shallower than the cavity 42 of the first shell 34. Rearward edges of the side walls 52 and a rear edge of the base wall 50 cooperate to provide the second shell 36 with a peripheral rear edge that defines an opening for providing access to the cavity. Upper portions of the side walls 52 are joined together to form an oval opening 54 from which a mounting structure 56 extends. The mounting structure 56 is adapted to be securely received in the ear hook 22 so as to secure the case 24 to the ear hook 22. Below the opening 54, front portions of the side walls 40 curve inwardly and are joined together to form a front bend that extends arcuately upward from the base wall 50 to the opening 54. The peripheral front and rear edges of the first and second shells 34, 36 are adapted to mate with each other when the first and second shells 34, 36 are secured together.

The battery 26 is a solid-state rechargeable battery or a foil rechargeable battery. The battery 26 is laminar and is especially configured to have a shape that conforms to at least a majority of the interior surfaces of the first shell 34. More specifically, the shape of the battery 26 conforms to substantially all of the interior surfaces of the side walls 40. In addition, the overall shape of the battery 26 substantially conforms to the overall shape of the conjoined side walls 40. Similar to the first shell 34, the battery 26 includes a pair of spaced-apart and opposing side walls 60 having top and rear portions that curve inwardly and are joined together to form a rear bend that arcuately extends upwardly and forwardly from bottom edges of the side walls 60 to front edges of the side walls 60. In this manner, the rear bend is arcuate in the lateral and longitudinal directions. A pair of terminals 62 are respectively disposed on opposing portions of interior surfaces of the side walls 60, toward the bottom edges thereof. Toward the top of each side wall 60, a pair of sound transmission holes 64 are formed in the side wall and extend therethrough.

The battery 26 is sized to snugly fit in the cavity 42 and may be releasably secured therein by friction or mechanical means or may be fixedly secured therein by glue or other securement means. When the battery 26 is disposed in the cavity 42, exterior surfaces of the side walls 60 of the battery 26 are disposed very close to or adjoining most of the interior surfaces of the side walls 40. In this manner, the battery 26 forms a type of layer that extends over most of the interior surfaces of the side walls 40. Additionally, when the battery 26 is disposed in the cavity 42, the sound transmission holes 64 of the battery 26 are aligned with the sound transmission holes 46 of the first shell 34 so as to form two pairs of sound transmission passages that extend through both the first shell 34 and the battery 26.

The electronics are preferably mounted to the second shell 36 and project rearwardly therefrom so as to be at least partially disposed between the side walls 60 of the battery 26 when the first shell 34 (with the battery 26) is attached to the second shell 36. When the hearing aid 20 is fully assembled and the first and second shells 34, 36 are attached to each other, the electronics are fully enclosed and the microphones 28 are disposed between the side walls 60 of the battery 26 such that listening openings 66 of the microphones 28 are aligned with the sound transmission holes 64 of the battery 26. In this manner, the sound transmission passages permit sound waves to travel through the first shell 34 and the battery 26 to the listening openings 66 of the microphones 28.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

What is claimed is:

1. A hearing aid for disposal around at least a portion of a user's ear, said hearing aid comprising:
a case configured to snugly curve around the user's ear, said case defining an interior space and including at least one interior surface;
electronics disposed in the interior space of the case, said electronics including a microphone and a speaker;
a battery mounted within the interior space and disposed proximate to the at least one interior surface of the case, said battery being laminar and configured to have a shape that conforms to the at least one interior surface of the case; and
wherein the battery is a solid-state rechargeable battery or a foil rechargeable battery.

2. The hearing aid of claim 1, wherein the case includes first and second sections that are removably attached to each other.

3. The hearing aid of claim 2, wherein the at least one interior surface is in the first section and wherein the shape of the battery conforms to a majority of the at least one interior surface.

4. The hearing aid of claim 3, wherein the battery is non-cylindrical.

5. The hearing aid of claim 4, wherein the at least one interior surface in the first section comprises a pair of spaced-apart interior surfaces, and wherein the battery has a pair of spaced-apart portions that conform to the interior surfaces, respectively.

6. The hearing aid of claim 4, wherein the first section is a removable cover and the at least one interior surface consists of a single interior surface of the cover, and wherein the shape of the battery conforms to a majority of the interior surface of the cover.

7. The hearing aid of claim 6, wherein the battery has first and second ends with first and second side edges extending therebetween, said first side edge being arcuate and said second side edge being irregular.

8. A hearing aid comprising:
electronic components including a microphone and a speaker;
a case defining an interior space within which the electronic components are disposed, said case including attached first and second sections, said first and second sections being detachable from each other so as to permit access to the electronic components, said first section having at least one interior surface;
a battery disposed within the interior space and mounted to the first section so as to be disposed proximate to the at least one interior surface thereof, said battery being laminar and configured to have a shape that conforms to the at least one interior surface of the first section; and
wherein the battery is a solid-state rechargeable battery or a foil rechargeable battery.

9. The hearing aid of claim 8, wherein the battery has positive and negative terminals, and wherein the electronics further includes a printed circuit board disposed in the interior space, said circuit board having contacts that are aligned with the positive and negative terminals of the battery.

10. The hearing aid of claim 9, wherein the printed circuit board has an overall shape that at least substantially conforms to the overall shape of the battery.

11. The hearing aid of claim 8, wherein the first section is a removable cover and the at least one interior surface consists of a single interior surface of the cover, and wherein the shape of the battery conforms to a majority of the interior surface of the cover.

12. The hearing aid of claim 11, wherein the battery has first and second ends with first and second side edges extending therebetween, said first side edge being arcuate and said second side edge being irregular.

13. The hearing aid of claim 8, wherein the at least one interior surface of the first section comprises a pair of spaced-apart interior surfaces, and wherein the battery has a pair of spaced-apart portions that conform to the interior surfaces, respectively.

14. The hearing aid of claim 8, further comprising:
a third section attached to the second section, said third section having an interior surface; and a
a second battery disposed within the interior space and mounted to the third section so as to be disposed proximate to the interior surface thereof, said second battery being laminar and configured to have a shape that conforms to a majority of the interior surface of the third section; and
wherein the second battery is a solid-state rechargeable battery or a foil rechargeable battery.

15. The hearing aid of claim 14, wherein the third section is detachable from the second section so as to provide access to the electronics.

16. The hearing aid of claim 15, wherein the second section is a frame to which the electronic components are mounted, and wherein the first and third sections are removable covers.

17. The hearing aid of claim 8, wherein the battery is non-cylindrical.

18. A hearing aid comprising:
a case having an interior surface and defining an interior space;
electronic components disposed within the interior space of the case;
a battery disposed within the interior space, said battery being configured to conform to the interior surface; and
wherein the battery has a non-cylindrical shape and is a solid-state rechargeable battery or a foil rechargeable battery.

19. The hearing aid of claim 18, wherein the case includes a cover having the interior surface, said cover being removable so as to provide access to the electronics.

20. The hearing aid of claim 19, wherein the shape of the battery conforms to a majority of the interior surface of the cover.

21. The hearing aid of claim 20, wherein the battery is mounted to the cover so as to be disposed proximate to the interior surface.

22. The hearing aid of claim 18, wherein the battery is laminar.

23. A hearing aid comprising:
a case defining an interior space, said case having at least one sound transmission hole extending therethrough for facilitating the passage of sound into the interior space;
electronic components disposed within the interior space of the case; and
a battery disposed within the interior space, said battery having at least one sound transmission hole extending therethrough that is aligned with the at least one sound transmission hole in the case.

24. The hearing aid of claim 23, wherein the battery is a solid-state rechargeable battery or a foil rechargeable battery.

25. The hearing aid of claim 24, wherein the case includes attached first and second sections, said first and second sections being detachable from each other so as to permit access to the electronic components, said first section having at least one interior surface; and
wherein the battery is disposed within the interior space, proximate to the at least one interior surface of the first section.

26. The hearing aid of claim 25, wherein the battery is configured to have a shape that conforms to a majority of the at least one interior surface of the first section.

27. The hearing aid of claim 26, wherein the at least one interior surface of the first section comprises a pair of spaced-apart interior surfaces, and wherein the battery has a pair of spaced-apart portions that conform to the interior surfaces, respectively.

28. The hearing aid of claim 27, wherein the battery includes a pair of terminals disposed on the portions of the battery, respectively.

29. The hearing aid of claim 28, wherein the terminals are disposed on interior surfaces of the portions of the battery, respectively.

30. A method of forming a hearing aid, said method comprising the steps of:
(a.) providing a case having first and second sections adapted to be removably attached to each other, said first section having at least one interior surface;
(b.) providing electronics that include a microphone and a speaker;
(c.) providing a rechargeable battery that has been especially configured to conform to the at least one interior surface of the first section, wherein the rechargeable battery is a solid-state rechargeable battery or a foil rechargeable battery;
(d.) mounting the battery to the first section of the case so as to be disposed proximate to the at least one interior surface thereof;
(e.) mounting the electronics to at least one of the first and second sections of the case when the first and second sections of the housing are separated from each other; and
(f.) after steps (d.) and (e.), attaching the first and second sections to each other so as to at least partially enclose the battery and the electronics.

31. The method of claim 30, wherein step (c.) is performed such that the battery is non-cylindrical.

32. The method of claim 31, wherein step (a.) is performed such that the at least one interior surface of the first section comprises a pair of spaced-apart interior surfaces, and wherein step (c.) is performed such that the battery comprises a pair of spaced-apart portions.

33. The method of claim 30, wherein step (c.) is performed such that the battery is laminar.
